(19) United States
(12) Patent Application Publication
(10) Pub. No.: US 2006/0253658 A1
(43) Pub. Date: Nov. 9, 2006

(54) Provisioning or de-provisioning shared or reusable storage volumes

(75) Inventors: Arnaud Airy Xavier Lucien Mathieu, Austin, TX (US); Joseph Paul Wigglesworth, Thornhill (CA); Zhe Xu, North York (CA); Alice Yeung, Markham (CA)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/121,412

(22) Filed: May 4, 2005

(51) Int. Cl. G06F 13/28; G06F 12/00

(52) U.S. Cl. 711/149; 711/170

(57) ABSTRACT

There is provided a method, apparatus and program product for managing shared or reusable storage volumes in a data processing system. A storage allocation pool having a plurality of storage volumes to be shared or reused by a plurality of authorized machines is created. Access to the plurality of storage volumes in the storage allocation pool by a machine of the plurality of authorized machines is enabled during a storage provisioning period and is disabled following storage de-provisioning. By providing the storage volumes in a storage allocation pool, all storage volumes in the pool can be used by a plurality of machines, and data on the storage volumes will persist even if no machine is accessing the storage volumes.

### BACKGROUND OF THE INVENTION

1. Technical Field

The present invention relates generally to the data processing field and, more particularly, to a method and apparatus for managing shared or reusable storage volumes in a data processing system.

2. Description of Related Art

In today's “on demand” environment, servers may be used for different purposes at different times. For example, consider an organization that has some machines set up for development and other machines set up for testing. At some point in time, the test team may require additional machines, and the development team may have machines that it is willing to lend to the test team.

Although all machines that are used for the same purpose, for example, for development or for testing, will have the same storage configuration and access the same storage volumes, the storage configuration of the development machines will usually be different from the storage configuration of the testing machines because they are used for a different purpose. Accordingly, in order to transfer machines from the development team to the test team, it is necessary to change the storage configuration of the machines to permit access to the shared testing storage volumes.

The process of providing users (servers) with access to storage volumes is referred to as “provisioning”. With current procedures, storage provisioning can only be done on available storage volumes, i.e. on storage volumes that are not assigned to any port and that are not used by any server. In many cases, however, multiple servers may wish to use the same storage volumes, i.e. to share the same storage volumes.

Furthermore, it is frequently the case that a user wishes to preserve the data that is used by a server so that the data can be reused at a later time. With current provisioning procedures, however, a storage volume is returned to the available pool following storage de-provisioning, resulting in the data on it being lost. There is currently no mechanism available to preserve data stored on storage volume following de-provisioning, so that the data can be reused at a later time.

There is, accordingly, a need for a method and apparatus for managing shared or reusable storage volumes in a data processing system that will allow servers to share or reuse storage volumes in such a manner that data stored on the storage volumes will persist, even after de-provisioning, so that the data may be reused at a later time.

### SUMMARY OF THE INVENTION

Embodiments of the present invention provide a method, apparatus and program product for managing shared or reusable storage volumes in a data processing system. A storage allocation pool having a plurality of storage volumes to be shared or reused by a plurality of authorized machines is created. Access to the plurality of storage volumes in the storage allocation pool by a machine of the plurality of authorized machines is enabled during a storage provisioning period and is disabled following storage de-provisioning. By providing the storage volumes in a storage allocation pool, all storage volumes in the pool can be used by a plurality of machines, and data on the storage volumes will persist even if no machine is accessing the storage volumes.

### BRIEF DESCRIPTION OF THE DRAWINGS

The novel features believed characteristic of embodiments of the invention are set forth in the appended claims. The embodiments of the invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which embodiments of the present invention may be implemented;

FIG. 2 is a diagram of a server cluster in accordance with an embodiment of the present invention;

FIG. 3 is a block diagram of a data processing system that may be implemented as a server in accordance with an embodiment of the present invention;

FIG. 4 is a table that summarizes criteria for a method and apparatus for managing shared or reusable storage volumes in a data processing system according to an embodiment of the present invention;

FIGS. 5A, 5B and 5C schematically illustrate a procedure for setting-up provisioning of shared or reusable storage volumes according to an embodiment of the present invention;

FIG. 6 schematically illustrates a procedure for accessing shared or reusable storage volumes during a provisioning period according to an embodiment of the present invention;

FIG. 7 schematically illustrates the status of shared or reusable storage volumes after storage de-provisioning according to an embodiment of the present invention;

FIG. 8 is a flowchart that illustrates a method for preparing storage volumes for provisioning according to an embodiment of the present invention; and

FIG. 9 is a flowchart that illustrates a method for sharing or reusing storage volumes during a provisioning period according to an embodiment of the present invention.

### DETAILED DESCRIPTION OF THE PREFERRED EMBODIMENT

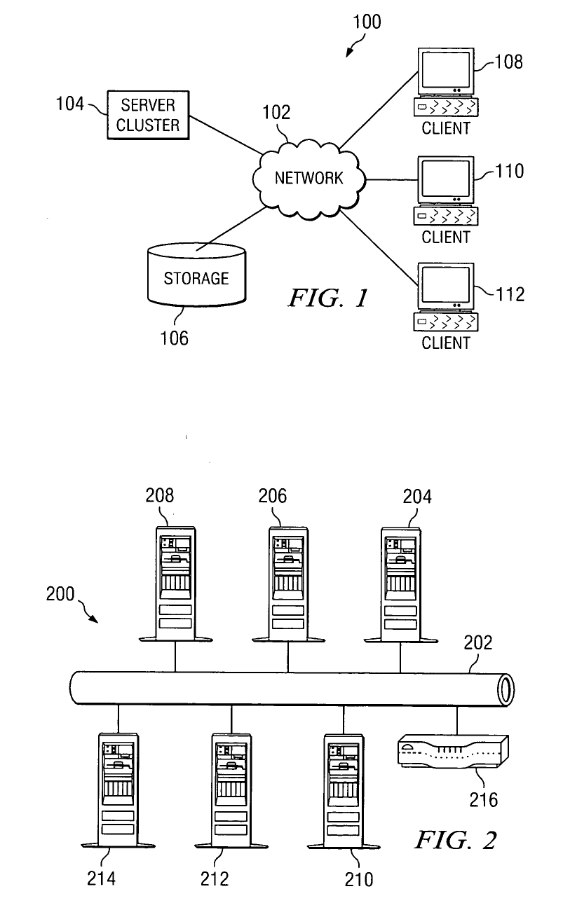

With reference now to the figures, FIG. 1, a pictorial representation of a network of data processing systems is depicted in which embodiments of the present invention may be implemented. Network data processing system 100 is a network of computers in which embodiments of the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server cluster 104 is connected to network 102 along with storage unit 106. In addition, clients 108, 110, and 112 are connected to network 102. These clients 108, 110, and 112 may be, for example, personal computers or network computers. In the depicted example, server cluster 104 provides data, such as boot files, operating system images, and applications to clients 108, 110, and 112. In these illustrative examples, server cluster 104 functions as an application server for a Website. As used herein, an application server is a server that contains an application that may be accessed remotely. In other words, the business logic or process is located on the server side. Clients 108, 110, and 112 are clients to server cluster 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Turning now to FIG. 2, a diagram of a server cluster is depicted in accordance with an embodiment of the present invention. Server cluster 200 contains fabric 202, which may be, for example, a bus, an Ethernet network, or some other inter-connect system. Servers 204, 206, 208, 210, 212, and 214 are connected to fabric 202 in server cluster 200.

Traffic scheduler 216 is connected to fabric 202 and initially receives all incoming traffic to server cluster 200. Traffic scheduler 216 may take the form of a router. Although shown as a separate physical component, traffic scheduler 216 may be a logical construct distributed through one or more servers in server cluster 200.

An initial request from a client is received by traffic scheduler 216. Load balancing algorithms and/or other policies may be used to direct this initial request to one of the servers in server cluster 200. Subsequent requests may be handled by traffic scheduler 216 or directly from the server through which a session is initiated. A session, also referred to as a user session, is the session of activity that a user with a unique IP address spends on a Website during a specified period of time. The number of user sessions on a Website is used in measuring the amount of traffic a Website gets.

The time frame of a user session may be set to different lengths of time, such as 5 minutes or 30 minutes. If the visitor comes back to the site within that time period, it is still considered one user session. Any number of visits within that time period is counted as one session.

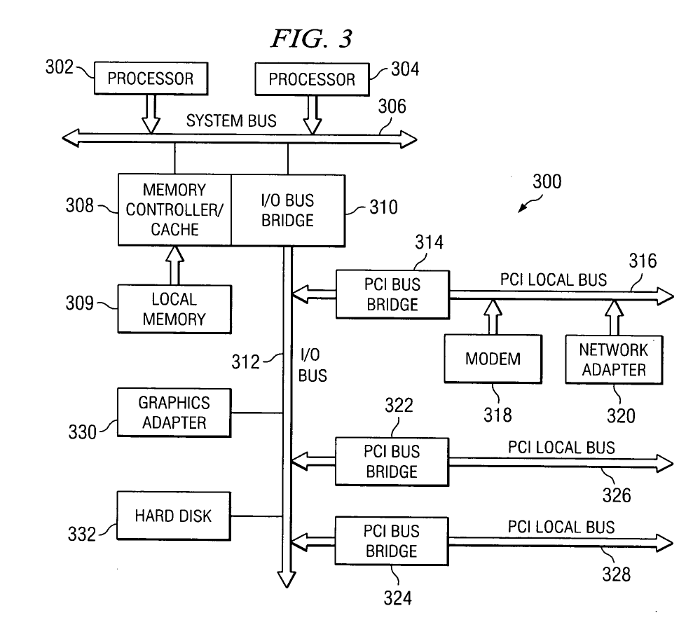

Referring to FIG. 3, a block diagram of a data processing system that may be implemented as a server, such as one of servers 204 to 214 in FIG. 2 or a traffic scheduler, such as traffic scheduler 216 in FIG. 2, is depicted in accordance with an embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O Bus Bridge 310 is connected to system bus 306 and provides an interface to I/O bus 312. Memory controller/cache 308 and I/O Bus Bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to clients 108, 110, and 112 in FIG. 1 may be provided through modem 318 and network adapter 320 connected to PCI local bus 316 through add-in connectors.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer™ pSeries system, a product of International Business Machines Corporation in Armonk, New York, running the Advanced Interactive Executive (AIX®) operating system or LINUX operating system.

Embodiments of the present invention provide a method and apparatus for managing storage volumes to be shared or reused by a plurality of data processing systems, such as a plurality of data processing systems 300 in FIG. 3, implemented as a plurality of servers, such as servers 204 to 214 in FIG. 2. In this regard, the plurality of servers is capable of accessing a plurality of storage volumes that are designated to be shared by the plurality of servers.

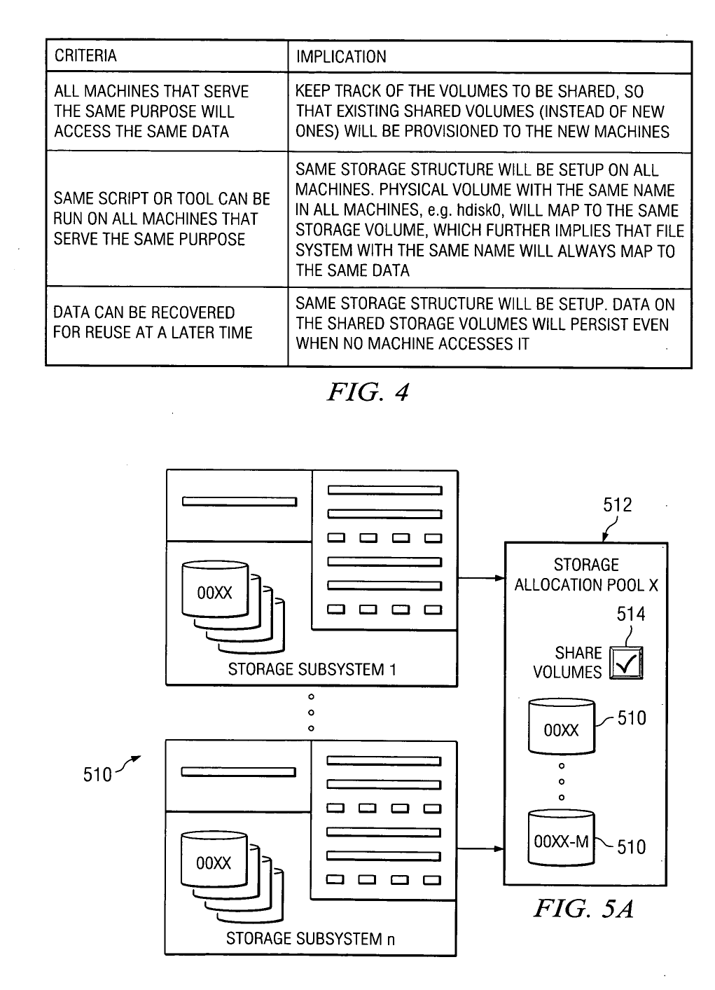

FIG. 4 is a table that summarizes criteria for a method and apparatus for managing or reusing shared storage volumes in a data processing system according to an embodiment of the present invention. Initially, as shown in FIG. 4, it is required that all machines that serve the same purpose will access the same data. This is because, as indicated previously, all machines that are used for the same purpose will have the same storage configuration and access and use the same data. This implies keeping track of the storage volumes to be shared so that existing shared volumes will be provisioned to new machines. Another criterion is that the same script or tool can be run on all machines that serve the same purpose. This implies that the same storage structure be set up on all machines that serve the same purpose, and that physical volume with the same name in all machines will map to the same storage volume. This further implies that file system with the same name will always map to the same data. A third criterion is that data stored in the storage volumes can be recovered for reuse at a later time. This implies that the same storage structure will be setup for each machine that serves the same purpose, and that data on shared storage volumes will persist even when no machine accesses it.

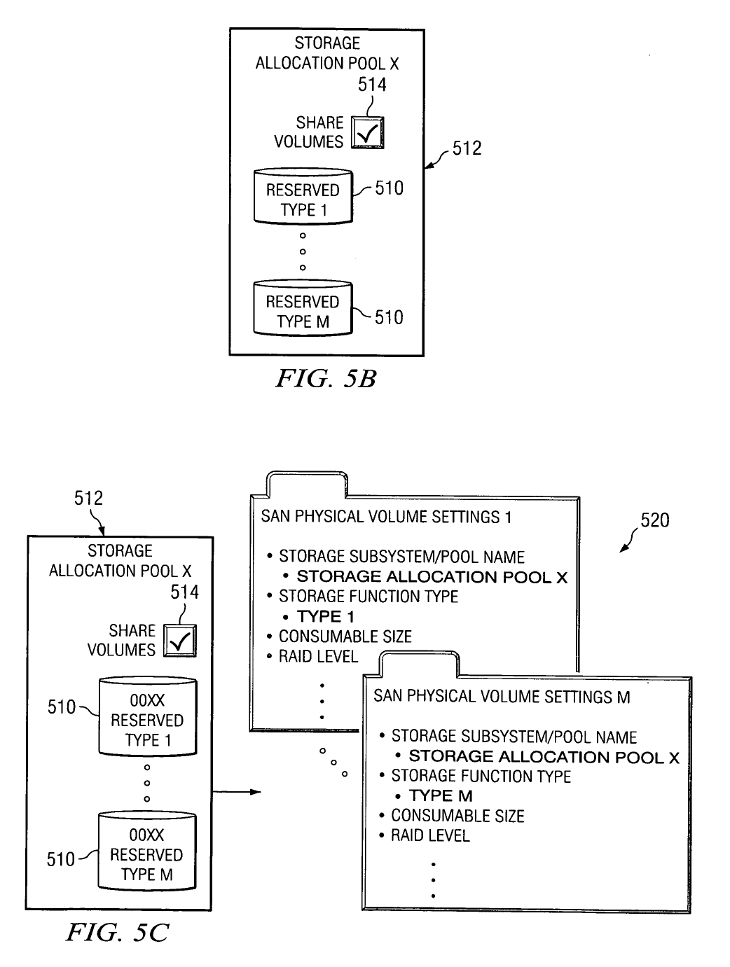

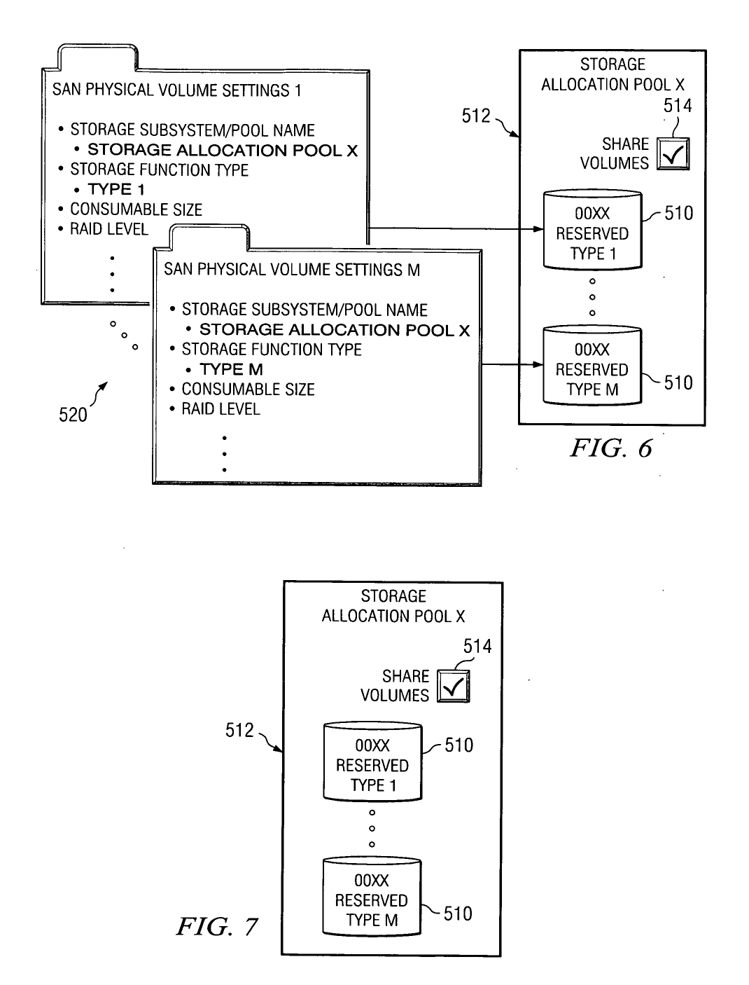

FIGS. 5A-7 are diagrams that schematically illustrate an automated procedure for provisioning and de-provisioning shared or reusable storage volumes that satisfy the above criteria. In particular, FIGS. 5A, 5B and 5C schematically illustrate a procedure for setting-up provisioning of shared or reusable storage volumes according to an embodiment of the present invention; FIG. 6 schematically illustrates a procedure for accessing shared or reusable storage volumes during a provisioning period according to an embodiment of the present invention; and FIG. 7 schematically illustrates shared or reusable storage volumes after storage de-provisioning according to an embodiment of the present invention.

With reference first to FIG. 5A, in order to enable automated storage provisioning according to a preferred embodiment of the present invention, storage volumes that are to be shared by a plurality of servers are identified. In FIG. 5A, storage volumes 510 from storage subsystems 1 . . . n, are identified. Identified storage volumes 510 are then assigned to be placed in storage allocation pool 512. Storage allocation pool 512 is an arbitrary group of storage volumes created to be shared or reused by a plurality of servers. Storage allocation pool is then marked, as schematically shown at 514, as being a shared pool of storage volumes. As will be explained hereinafter, by marking the pool as being shared, when an authorized server requests storage volume from the pool, the volume state of the storage volume will be ignored.

With reference now to FIG. 5B, each storage volume 510 in storage allocation pool 512 is designated as having a volume state other than AVAILABLE. In FIG. 5B, the state is shown as RESERVED, although other non-available states may be designated, if desired. Designating the storage volumes as having a state other than AVAILABLE prevents unauthorized servers from gaining access to storage allocation pool 512, while, as will be explained hereinafter, authorized servers will be enabled to access the storage volumes in the pool during a provisioning period.

As also shown in FIG. 5B, each storage volume 510 is marked with a unique storage function type (Type 1 . . . Type m). This will ensure that the same physical volume settings will always map to the same storage volume.

With reference to FIG. 5C, physical volume settings are then created for each storage volume 510 in storage allocation pool 512. In particular, the properties of each physical volume setting have to match the properties of the associated storage volume. In addition, it is necessary to specify in the physical volume settings that the storage volume has to be picked from the shared pool. Reference number 520 schematically illustrates creating SAN (Storage Area Network) physical volume settings for each of storage volumes 510 in storage allocation pool 512. Basically, a storage template is defined that contains SAN physical volume settings objects that point to the shared storage allocation pool and match the storage volume capabilities.

FIG. 6 schematically illustrates a procedure for accessing shared or reusable storage volumes during a provisioning period according to an embodiment of the present invention. As depicted in FIG. 6, during a provisioning period authorized servers locate the particular storage volume 510 that matches the requirements specified in the SAN physical volume settings 520. There are two ways that the storage volumes can be picked during the provisioning period: (1) the SAN physical volume settings can specify that a storage volume has to be picked from a storage subsystem in which a storage volume physically resides, or (2) the SAN physical volume settings can specify that the storage volume has to be picked from the storage allocation pool. Although the storage volumes in the storage allocation pool will be in a state other than AVAILABLE, as indicated above, the state is ignored if the storage volumes in the storage allocation pool are shared. In this way an authorized user can access and use the storage volumes.

In order to ensure that the storage volume state will not change to AVAILABLE during the provisioning period, one of the following can be done:
Do not unmap a storage volume from the subsystem's fibre adapter ports. This will keep the storage volume in an ASSIGNED state.
Explicitly update the storage volume state from AVAILABLE to RESERVED.

Following the provisioning period, de-provisioning is performed when the machine no longer needs to access the storage volume. FIG. 7 schematically illustrates the status of shared or reusable storage volumes after storage de-provisioning according to an embodiment of the present invention. As shown, storage volumes 510 in storage allocation pool 512 remain designated as being in a RESERVED state or in another state that is not an AVAILABLE state. As a result, an unauthorized server that attempts to access the storage allocation pool will be unable to do so, and this will ensure that any data on the storage volumes will persist and not be erased.

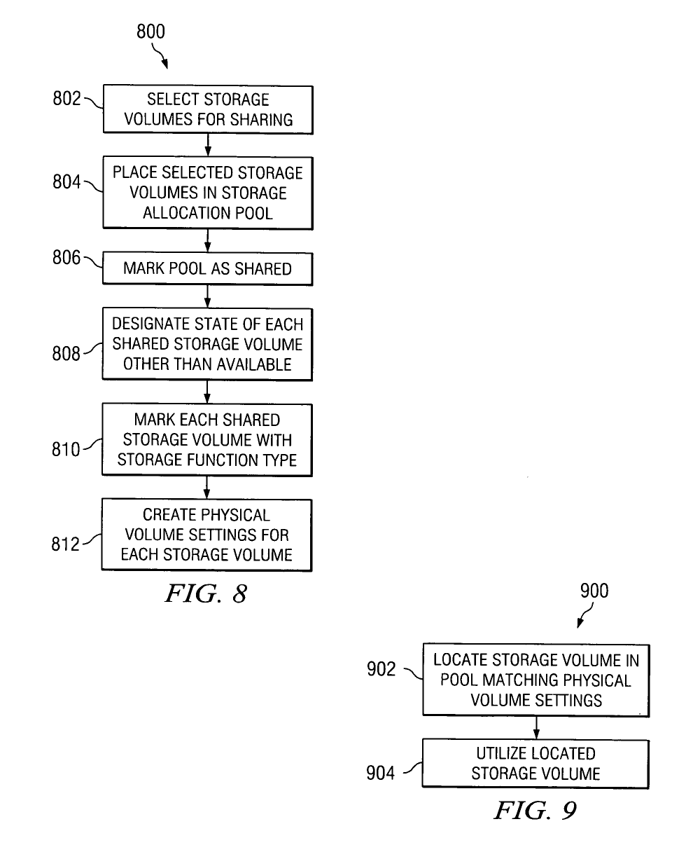

FIG. 8 is a flowchart that illustrates a method for preparing storage volumes for provisioning according to an embodiment of the present invention. The method is generally designated by reference number 800, and begins by selecting storage volumes that will be shared by a plurality of servers (Step 802). The selected storage volumes are then placed in a storage allocation pool (Step 804), and the storage allocation pool is marked as shared (Step 806). The state of each shared storage volume is then designated as being a state other than AVAILABLE (Step 808), and is also marked with a storage function type (Step 810). Physical volume settings are then created for each storage volume to match the properties of the associated storage volume (Step 812).

FIG. 9 is a flowchart that illustrates a method for sharing or reusing storage volumes during a provisioning period according to an embodiment of the present invention. The method is generally designated by reference number 900, and as shown, an authorized server locates a storage volume that matches the requirements specified in SAN physical volume settings (Step 902). The server then accesses and utilizes the located storage volume (Step 904). Since the volumes in the stored allocation pool are shared, the storage volume state will be ignored.

Embodiments of the present invention thus provides a method, apparatus and program product for managing shared or reusable storage volumes in a data processing system. A storage allocation pool having a plurality of storage volumes to be shared or reused by a plurality of authorized machines is created. Access to the plurality of storage volumes in the storage allocation pool by a machine of the plurality of authorized machines is enabled during a storage provisioning period and is disabled following storage de-provisioning. By providing the storage volumes in a storage allocation pool, all storage volumes in the pool can be used by a plurality of machines, and data on the storage volumes will persist even if no machine is accessing the storage volumes.

It is important to note that while embodiments of the present invention has been described in the context of a fully functioning data processing system, those of ordinary skill in the art will appreciate that the processes of embodiments of the present invention are capable of being distributed in the form of a computer usable medium of instructions and a variety of forms and that embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

The description of embodiments of the present invention have been presented for purposes of illustration and description, and were not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for managing shared or reusable storage volumes, comprising:
creating a storage allocation pool having a plurality of storage volumes to be shared or reused by a plurality of authorized machines;
enabling access to the plurality of storage volumes in the storage allocation pool by a machine of the plurality of authorized machines during a storage provisioning period; and
disabling access to the plurality of storage volumes in the storage allocation pool by the plurality of authorized machines following storage de-provisioning.

2. The method according to claim 1, and further comprising:
preventing access to the plurality of storage volumes in the storage allocation pool by an unauthorized machine during the storage provisioning period.

3. The method according to claim 2, wherein the preventing step comprises:
designating each of the plurality of storage volumes in the storage allocation pool as being in an unavailable state.

4. The method according to claim 3, wherein the enabling step comprises:
permitting the machine of the plurality of machines to ignore the unavailable state during the storage provisioning period.

5. The method according to claim 4, wherein the permitting step comprises:
marking the storage allocation pool as being a shared storage allocation pool.

6. The method according to claim 1, wherein the disabling step comprises:
designating each of the plurality of storage volumes as being in an unavailable state following de-provisioning.

7. The method according to claim 1, and further comprising:
assigning each of the plurality of storage volumes in the storage allocation pool with a different storage volume type; and
creating physical volume settings for each of the plurality of storage volumes in the storage allocation pool, wherein the same physical volume settings will always map to the same storage volume.

8. The method according to claim 7, wherein during the storage provisioning period, the machine of the plurality of authorized machines locates and accesses a storage volume that matches requirements specified by the physical volume settings.

9. The method according to claim 1, wherein the plurality of authorized machines comprise a plurality of servers.

10. An apparatus for managing shared or reusable storage volumes in a data processing system, comprising:
a storage allocation pool having a plurality of storage volumes to be shared or reused by a plurality of authorized machines; and
a mechanism for controlling access to the plurality of storage volumes in the storage allocation pool by enabling a machine of the plurality of authorized machines to access the plurality of storage volumes during a storage provisioning period, and by disabling access to the plurality of storage volumes in the storage allocation pool by the plurality of authorized machines following storage de-provisioning.

11. The apparatus according to claim 10, wherein the plurality of storage volumes in the storage allocation pool are designated to prevent access to the plurality of storage volumes by an unauthorized machine during the storage provisioning period.

12. The apparatus according to claim 11, wherein the plurality of storage volumes are designated as being in an unavailable state during the storage provisioning period.

13. The apparatus according to claim 12, wherein the storage allocation pool is marked as being a shared storage allocation pool, and wherein the storage volume manager enables the machine of the plurality of authorized machines to ignore the unavailable state during the storage provisioning period.

14. The apparatus according to claim 10, wherein the the plurality of storage volumes are designated as being in an unavailable state following de-provisioning.

15. The apparatus according to claim 10, wherein each of the plurality of storage volumes in the storage allocation pool is assigned a different storage volume type, and wherein the apparatus further comprises:
a mechanism for providing physical volume settings for each of the plurality of storage volumes in the storage allocation pool, wherein the same physical volume settings will always map to the same storage volume.

16. The apparatus according to claim 10, wherein the plurality of machines comprises a plurality of servers.

17. A computer program product, comprising computer executable instructions embodied in a computer usable medium, for managing shared or reusable storage volumes, the computer program product comprising:
first instructions for creating a storage allocation pool having a plurality of storage volumes to be shared or reused by a plurality of authorized machines;
second instructions for enabling access to the plurality of storage volumes in the storage allocation pool by a machine of the plurality of authorized machines during a storage provisioning period; and
third instructions for disabling access to the plurality of storage volumes in the storage allocation pool by the plurality of authorized machines following storage de-provisioning.

18. The computer program product according to claim 17, and further comprising:
fourth instructions for preventing access to the plurality of storage volumes in the storage allocation pool by an unauthorized machine during the storage provisioning period.

19. The computer program product according to claim 18, wherein the fourth instructions comprises:
fifth instructions for designating each of the plurality of storage volumes as being in an unavailable state.

20. The computer program product according to claim 19, wherein the second instructions comprises:
sixth instructions for permitting the machine of the plurality of machines to ignore the unavailable state during the storage provisioning period.

21. The computer program product according to claim 20, wherein the sixth instructions comprises:
seventh instructions for marking the storage allocation pool as being a shared storage allocation pool.

22. The computer program product according to claim 17, wherein the third instructions comprises:
eighth instructions for designating the plurality of storage volumes as being in an unavailable state following de-provisioning.

23. The computer program product according to claim 17, and further comprising:
ninth instructions for assigning each of the plurality of storage volumes in the storage allocation pool with a different storage volume type; and
tenth instructions for creating physical volume settings for each of the plurality of storage volumes in the storage allocation pool, wherein the same physical volume settings will always map to the same storage volume.

24. The computer program product according to claim 23, and further comprising:
eleventh instructions for a machine to locate and uses a storage volume that matches requirements specified by the physical volume settings during the storage provisioning period.
